(19) United States
(12) Patent Application Publication
(10) Pub. No.: US 2014/0306117 A1
(43) Pub. Date: Oct. 16, 2014

(54) APPARATUS AND METHOD FOR RADIATION DETECTION

(71) Applicants: Antonin Vacheret, Oxford (GB); Alfons Weber, Oxford (GB); Yuri Shitov, London (GB)

(72) Inventors: Antonin Vacheret, Oxford (GB); Alfons Weber, Oxford (GB); Yuri Shitov, London (GB)

(73) Assignee: ISIS INNOVATION LIMITED, Oxford (GB)

(21) Appl. No.: 14/239,046

(22) PCT Filed: Aug. 24, 2012
(86) PCT No.: PCT/GB2012/052097

§ 371 Date: May 19, 2014

(30) Foreign Application Priority Data
Aug. 25, 2011 (GB) 1114699.0
Oct. 11, 2011 (GB) 1117541.1

(51) Int. Cl. G01T 3/06

(52) U.S. Cl. CPC G01T 3/06
USPC 250/366; 250/361 R

(57) ABSTRACT

Embodiments of the invention provide a radiation detector, comprising a convertor comprising an inorganic scintillator for absorbing incident neutrons and outputting photons, a light collecting body arranged in relation to a wavelength shifting fibre for receiving photons from the convertor and directing the photons to the wavelength shifting fibre, and one or more photo-detectors arranged to receive photons from the wavelength shifting fibre and output electrical signals in response thereto.

Embodiments of the present invention relate to radiation detectors. In particular, although not exclusively, some embodiments of the invention relate to neutron radiation detectors. However, some embodiments of the invention are also responsive to other radiations types, such as antineutrinos and/or muons.

### BACKGROUND

Neutron radiation is often detected by radiation detectors based upon ³He. However, ³He is becoming increasingly expensive and unavailable. Furthermore such detectors are often only responsive to neutron radiation and the additional detection of other types of radiation, such as antineutrinos may be desirable in some instances.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying figures, in which:

FIG. 1 shows a detector according to an embodiment of the invention;

FIG. 2 shows the detector shown in FIG. 1 in use;

FIG. 3 shows detectors according to further embodiments of the invention;

FIG. 4 shows detectors according to still further embodiments of the invention;

FIG. 5 shows a detector according to another embodiment of the invention;

FIG. 6 illustrates an output of a photo-detector arising for different radiation types;

FIG. 7 shows a detector assembly according to an embodiment of the invention;

FIG. 8 shows a detector assembly according to another embodiment of the invention; and

FIG. 9 shows a detector according to a further embodiment of the invention.

### DETAILED DESCRIPTION OF EMBODIMENTS OF THE INVENTION

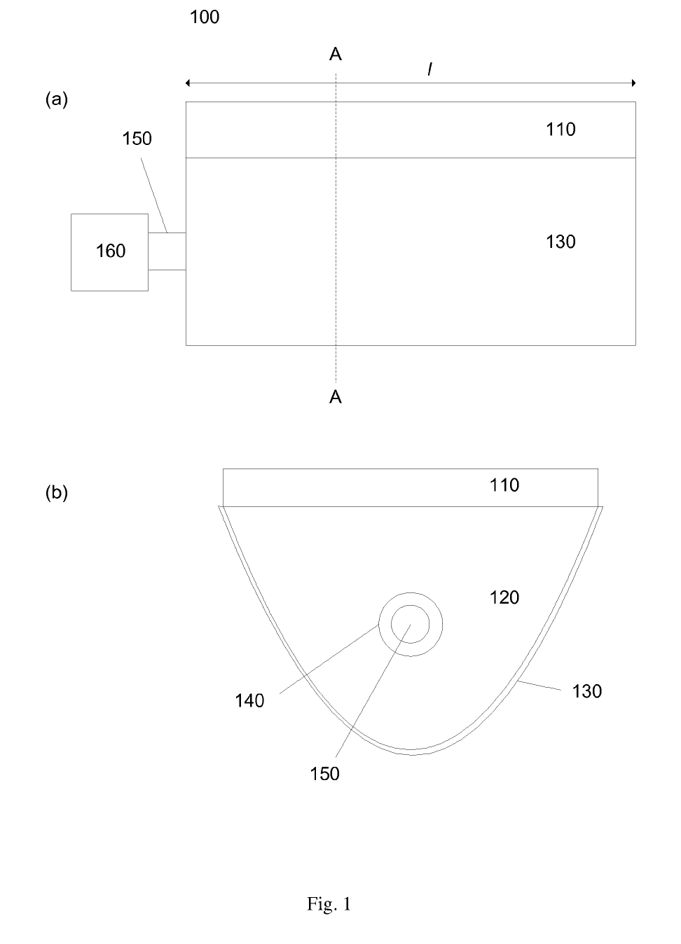

FIG. 1 illustrates a radiation detector 100 according to an embodiment of the invention. The detector according to the first embodiment is particular envisaged for neutron detection. However, as will be described, some embodiments of the present invention are also provided for detection of other radiation types, such as antineutrinos. FIG. 1(a) is a side view of the detector and FIG. 1(b) is an axial cross section along the vertical line A-A indicated in FIG. 1(a).

The detector 100 is an elongate detector having a length l as indicated in FIG. 1 which may be much greater than its width or depth. The detector 100 may have a length of between 0.01 m and 5 m or greater, such as 8 m, although it will be realised that the present invention is not limited in this respect.

The detector 100 comprises a convertor layer 110 for converting incident neutrons to photons (light), a light concentrating body 120 for directing photons output by the convertor layer toward a wavelength shifting fibre 150 which runs along an elongate axis of the detector 100.

The fibre 150 is arranged in a channel 140 through the body 120. In some embodiments, a dimension of the channel 140 is determined such that an air gap exists between an exterior of the fibre, which may be defined by a cladding of the fibre 150, and an interior surface of the channel. The channel may have a circular shape. One of more exterior surfaces of the body 120 are covered with a layer to provide a reflective surface for preventing light exiting the body i.e. for reflecting light toward the fibre 150. The fibre 150 exits the body 120 at one or both ends thereof to communicate light to one or more photo-detectors 160 arranged at one or both ends of the detector 100. It will be realised that more than one channel and fibre may be provided through the body 120.

As noted above, the convertor layer 110 is provided for converting incident neutrons to photons. The convertor layer 110 includes a substance for converting to neutrons to charged particles. Various substances are known and may be used for this purpose, such as boron (¹⁰B) and lithium (⁶Li). The ⁶Li isotope may be preferred as its reaction with neutrons releases a charged particle without gamma radiation unlike, for example, ¹⁰B. The reaction is illustrated as:

n+⁶Li(Σ=7.5%)→³H(2.75 MeV)+⁴He(2.05 MeV), σ=940 barn

where Σ is abundance of the isotope in nature and [symbol] is the thermal neutron absorption cross-section. The isotope may be ⁶Li which may be used in combination with another element such as fluoride to provide ⁶LiF.

Since the convertor layer 110 particularly captures thermal energy neutrons, the body 120 may be formed from a hydrogenous material, such as wax, plastic, polystyrene etc., to act as a neutron moderator to slow incident neutrons and increase a response of the detector 100 to fast neutrons. Some embodiments of the invention include further moderators, as will be explained.

Charged particles released within the convertor 110 are further converted to photons by an inorganic scintillator within the convertor 110. The inorganic scintillator may be zinc sulfide (ZnS). Zinc sulfide may be preferred because it is relatively cheap and has a low quenching factor, thus producing large amounts of light for heavy nuclei. However, other inorganic scintillator materials may be used. The convertor layer 110 may also include a binder material. Since ⁶LiF:ZnS is relatively opaque, and thus light does not travel far through the material, the convertor layer is relatively thin i.e. up to about 0.5 mm thick. The light output by the convertor layer 110 in some embodiments has a wavelength corresponding to blue light i.e. around 450 nm.

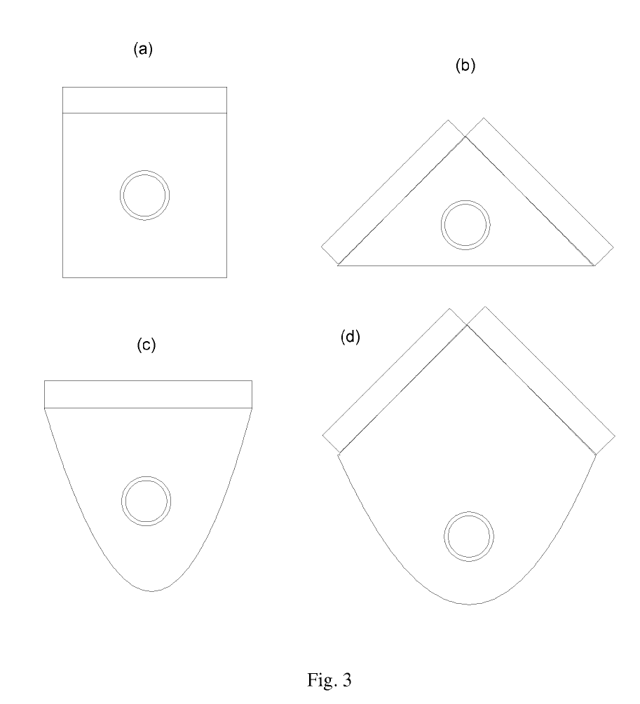

The body 120 is attached to a major planar surface of the convertor layer 110 to collect light output by the convertor layer 110. The body 120 may be attached to the convertor 110 by an optical coupling layer, such as a transparent adhesive. The body is formed from a generally transparent material, such as a plastic. The plastic material may be polystyrene, although the present invention is not limited in this respect. The body 120 shown in FIG. 1 is coupled to the convertor by a substantially flat surface and has a cross sectional shape which is generally parabolic. The parabolic shape may be preferred for directing light received from the convertor toward the fibre 150, although as shown in FIG. 3 other cross-sectional shapes may be envisaged.

The light reflective layer or coating 130 may be specular or diffusely reflective. In some embodiments, the reflective layer 130 may be formed by a paint applied to one or more outer surfaces of the body 120. The channel 140 through which the fibre is arranged axially through the body 120 is positioned at a location such that the outer shape of the body 120 in combination with the reflective layer 130 directs light toward the channel 140 and fibre located therein. As mentioned above, the channel may have a larger interior dimension (diameter) than the external dimension of the fibre 150. Advantageously this increases an amount of light communicated along the fibre 150 and/or an amount of light collected from the body 120. A refractive index of air is around 1, whereas a cladding layer of the optical fibre has a relatively higher refractive index. Thus the difference in refractive index causes a greater degree of total internal reflection within the fibre 150, thus increasing the amount of light communicated along the fibre 150 to the detector 160. Other embodiments of the invention may be envisaged where a gap between the fibre 150 and the channel 140 is filled with a material. The material may be different from that of the body 120.

The wavelength shifting fibre 150 includes a material which is absorbent to the scintillation light output by the convertor 110 and directed thereto by the body 120. The material fluoresces to output light having a different wavelength, such as green light, which is retained within the fibre 150 by total internal reflection and communicated to the one or more photo-detectors 160.

The photo-detector(s) are provided for receiving light communicated to one or more ends of the fibre and converting the incident light to electrical signals. The photo-detector(s) 160 may be solid state devices, such as a photo-diode, silicon photomultiplier (SiPM), a Geiger mode Photo-diode array, or a device such as a photo-multiplier tube, as will be appreciated by the skilled person.

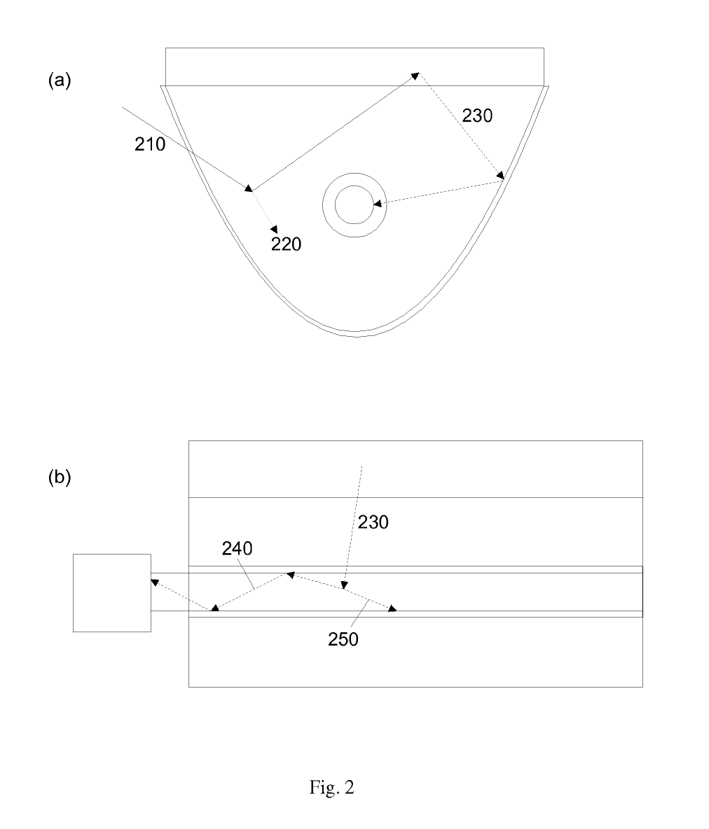

FIG. 2 illustrates an example of the detector 100 shown in FIG. 1 in use. Reference numerals referring to the components shown in FIG. 1 are omitted in FIG. 2 for clarity. FIG. 2(a) illustrates the detector 100 in axial cross section particularly in relation a neutron 210 which impinges upon the detector 100, whereas FIG. 2(b) illustrates the detector in longitudinal cross section in relation to photons within the detector 100.

Referring to FIG. 2(a) an incident neutron 210 has an energy greater than thermal energy and enters the detector 100. In the example shown in FIG. 2(a) the neutron 210 enters the body 120 and interacts with the material of the body. In particular, the neutron 210 interacts with one or more hydrogen atoms of the plastic body 120 via an elastic collision, such that a recoil proton 220 is caused, a direction of the neutron 210 is changed and the energy of the incident neutron 210 is reduced. Further interactions may occur within the detector 100 which are not shown in FIG. 2. Eventually, following the various interactions of the neutron 210 with matter, the energy of the neutron 210 is reduced to thermal energy. The neutron subsequently reacts with an atom of the convertor 110 to release one or more charged particles which may be daughter nuclei of a reaction of the neutron 210 with the convertor material. In some embodiments the neutron may react with lithium in the convertor layer. In other embodiments, the neutron may react with another isotope in the convertor, such as gadolinium. The charged particles may include alpha particles which subsequently interact with the inorganic scintillation material, such as ZnS in the convertor 100 to produce resultant photons 230 as illustrated in FIGS. 2(a) and 2(b). Whilst some photons may intersect the fibre optic 150 directly i.e. without reflection, many photons will be internally reflected into the body 120 by the reflective layer, as illustrated in FIG. 2(a).

At least some photons intersecting the fibre 150 having a first wavelength (typically blue) substantially as emitted by the convertor 110 are captured by a fluorescent dye within the fibre 150 which re-emits photons having a second, different, wavelength (typically green). The emitted photons are indicated in FIG. 2(b) with reference numerals 240, 250 to indicate a direction of travel of the emitted photons. At least some of the photons 240 are caused, by total internal reflection within the fibre 150, to travel toward the photodetector 160 which outputs a corresponding electrical signal in response to detection of the photons 240. Some photons 250 will travel in an opposite direction along the fibre 150 and may be detected by a second photodector (not shown) at an opposite end of the fibre 150. In embodiments comprising two photodetectors, a control unit (not shown) may compare a timing of the electrical signals output by the photodetectors to determine a longitudinal position along the detector at which the neutron 210 interacted with the convertor 110 i.e. a detection position of the neutron. Photons emitted in response to the neutron relatively closer to the photodetector at one end of the detector 100 will cause a corresponding electrical signal to be output before a signal at the opposed end of the detector 100.

FIG. 3 illustrates detectors according to further embodiments of the invention. The detectors are shown in FIG. 3 in axial cross section. The detectors are each elongate i.e. having a longitudinal axis substantially longer than axial width, but have differently shaped cross sections and, in some embodiments, varying numbers of convertor layers.

FIG. 3(a) illustrates a detector 310 according to an embodiment of the invention having a square cross section. FIG. 3(b) illustrates a detector 320 according to an embodiment of the invention having a triangular cross section. The detector 320 shown in FIG. 3(b) includes two convertor layers, each as described with reference to FIGS. 1 and 2. It will be realized that a triangular detector may be envisaged only having one convertor layer i.e. affixed to one face of the body. Furthermore, the two convertor layers may be formed as a single layer covering two faces of the body i.e. “wrapped over” the top of the body. FIG. 3(c) illustrates a detector having a parabolic cross section. FIG. 3(d) illustrates an embodiment having a triangular upper portion and a parabolic lower portion.

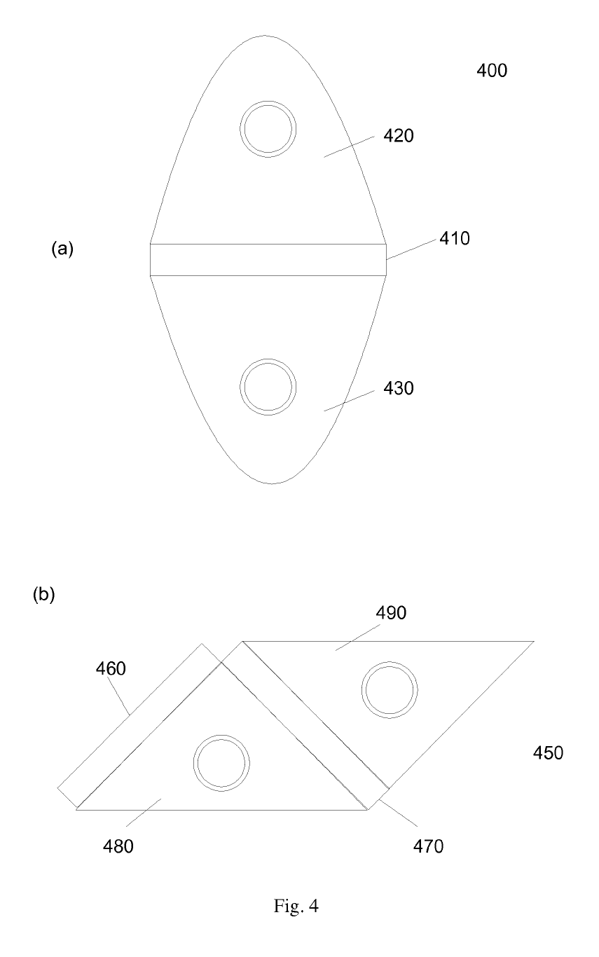

FIG. 4 illustrates detector structures embodiments of the invention having a plurality of body portions adjacent to each convertor layer.

FIG. 4(a) illustrates a detector structure 400 according to an embodiment comprising a convertor layer 410 as previously described in relation to FIGS. 1 and 2 and two bodies 420, 430 each as described with reference to FIGS. 1 and 2. Each body in FIG. 4(a) has a parabolic cross section, although it will be realised that bodies having other cross sections may be used. The convertor layer 410 is sandwiched between substantially flat surfaces of the bodies 420, 430 such that the bodies 420, 430 capture photons emitted from the convertor 410. The use presence of a plurality of bodies 420, 430 disposed adjacent to the convertor 410 increases a probability of emitted photons causing the detection of resultant wavelength shifted photons from eh fibre in each body since more photons emitted from the convertor are transmitted to a body i.e. photons are captured from both sides of the convertor 410.

FIG. 4(b) illustrates a detector structure 450 according to a further embodiment of the invention. The detector structure shown comprises two convertor layers 460, 470 and two bodies 480, 490 wherein one of the convertor layers 470 is disposed between the two bodies 480, 490. The bodies each have a triangular axial cross section such that a detector structure may be formed which comprises two or more bodies. A further body may be located adjacent to the convertor layer 460 and this repletion of convertor layers and bodies in the structure may be continued indefinitely to from a general flat detector structure having which is relatively wide.

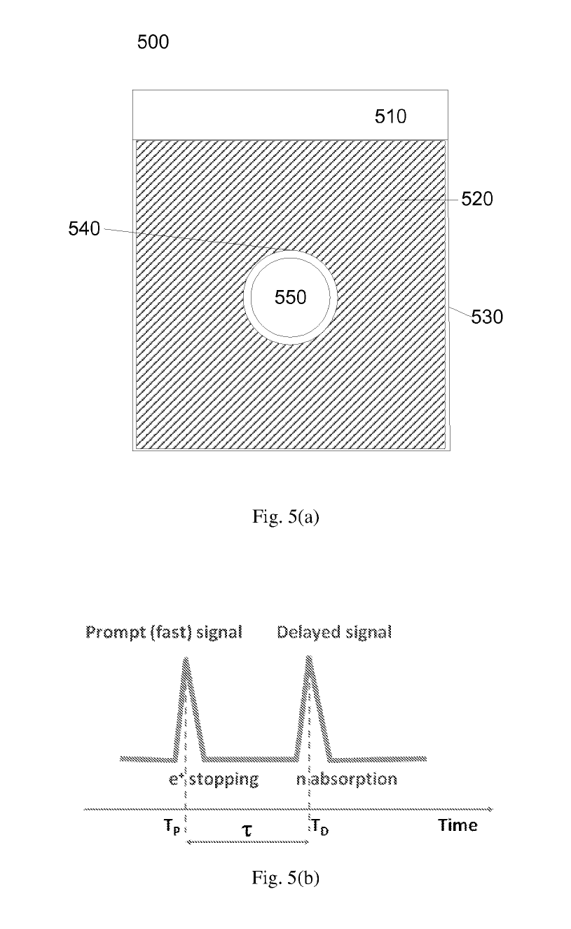

FIG. 5 illustrates a detector 500 according to a further embodiment of the invention. Unless otherwise described, the detector 500 is identical and comprises like components to those detectors previously described, for example as shown in FIG. 1. The detector 500 is adapted to be further responsive to charged particles, such as protons, electrons, positrons, muons, etc. Due to the sensitivity to charged particles other types of radiation such as antineutrinos may be detected by reactions which result in charged particles. The detector 500 is also responsive to neutrons, as in the previously described embodiments. The enhanced sensitivity of the detector 500 to charged particles, such as positrons, also allows the detection of other neutral particles, such as antineutrinos, as will be explained.

The detector 500 comprises a convertor layer 510 which includes an inorganic scintillator, a light concentrating body 520 having an upper planar surface generally in contact with the convertor layer 510, wherein the body 520 is surrounded by a reflective layer 530 around its periphery not covered by the convertor 510, as in the previously described embodiments. It will be realised that the reflective layer 530 may also cover outer surfaces of the convertor layer 510 as previously described. Furthermore, as previously described, a channel 540 runs through the body along an elongate longitudinal axis of the detector 500 and a wavelength shifting fibre 550 is arranged in the channel to communicate light to one or more photo-detectors (not shown) at one or both ends of the detector 500.

In order to provide sensitivity to charged particles, the body 520 comprises a plastic organic scintillator. The plastic scintillator includes a fluor such as 2,5-diphenyloxazole (PPO) and 1,4-di-(5-phenyl-2-oxazolyl)-benzene (POPOP). An antineutrino having an energy above 1.81 MeV may be detected following an inverse beta decay process with a hydrogen atom of the body 520, which as discussed is formed by a hydrogen rich material, such as polystyrene. The beta decay process may be described as:

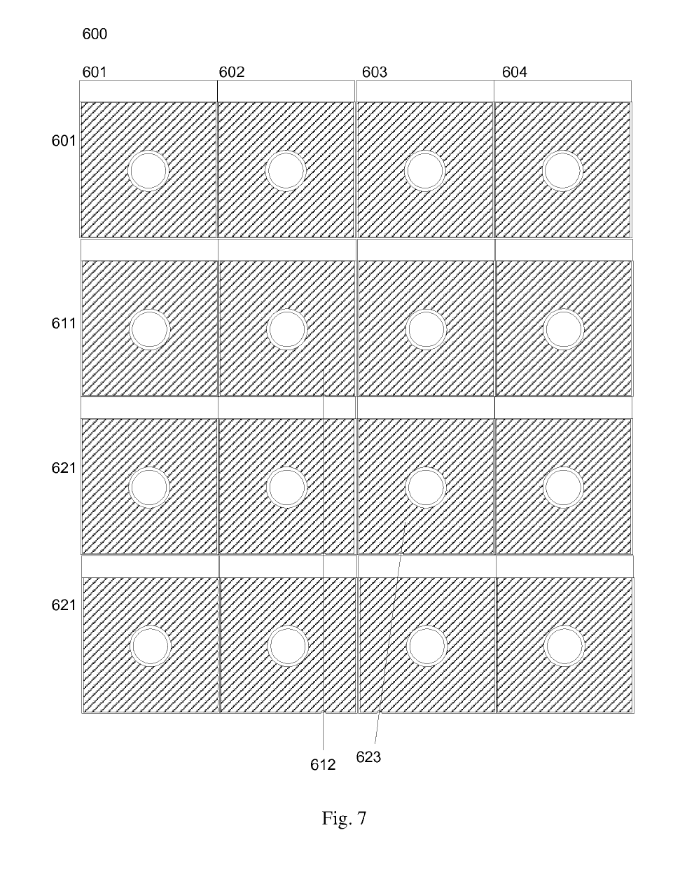

V̅ₑ+p→e⁺+n

where the positron (e⁺), typically having a mean energy of around 3.5 MeV, and annihilates with an electron to produce gamma radiation in the form of two 511 keV gamma rays. Antineutrino detection according to embodiments of the invention utilises coincident detection of a prompt event and a delayed event. Detection of the positron (e⁺) corresponds to the prompt event. The positron is detected by interaction with the plastic scintillator present in the body 520 which generates photons in the body 520, at least some of which reach the fibre 550 and lead to subsequently wavelength shifted photons in the fibre 550 being detected by the one or more photo-detectors (not shown in FIG. 5). As will be explained, the detection of the positron enables a determination of the location of antineutrino interaction. Similarly, other charged particles, such as muons (μ⁻), may also be detected in this manner. The charged particles may not necessarily result from interactions within the detector i.e. may impinge upon the detector from an external source. Advantageously, the detection of muons may be useful to detect shielded radiation sources. For example, where a source of radiation is shielded by a high-Z material, such as lead, it may be consequently more difficult to detect neutrons emitted from the source. By detection of muons information about the shielding may be derived as in muon tomography techniques. As will be appreciated, the apparatus shown in and described with reference to FIG. 7 may be useful for muon tomography. Furthermore, combined sensitivity to neutron, muon and gamma radiation enables increased detection of radiation sources, such as concealed radiation sources. For example a low-Z material may provide shielding to neutrons, whereas a high-Z material may provide shielding to gamma radiation. However, to effectively shield a radiation source against neutron, muon and gamma radiation is very difficult.

The reaction also releases a neutral particle n which may be a neutron. The neutron may be detected in the same way as an incident neutron not resulting from an internal reaction within the detector 500 i.e. the neutron may be captured by the a substance in the convertor layer 510 for converting to neutrons to charged particles, such a ⁶LiF. As a result, photons resulting from a reaction of the charged particles with the scintillation material, such as ZnS, in the convertor layer 510, and possibly also the body 520, cause resultant wavelength shifted photons in the fibre 550 being detected by the one or more photo-detectors. The detection of photons corresponding to the neutron absorption in the convertor layer 510 corresponds to the delayed event.

FIG. 5(b) illustrates a signal corresponding to an electrical output of a photo-detector arranged to receive light from the fibre 550 shown in FIG. 5(a). As shown in FIG. 5(b) the output from the photo-detector includes a first peak at a time T_{P} corresponding to the prompt event and a second peak at a time T_{D} corresponding to the delayed event where T_{P} and T_{D} are separated by a time interval τ. The time | between neutron emission, corresponding to the prompt event, and neutron absorption, corresponding to the delayed event depends on the choice of neutron absorber material. In pure hydrogenous media neutrons are captured during ˜200 |s after its emission in the inverse beta decay process. In presence of a neutron absorber material, such as in the convertor layer 110, neutrons are captured up to ˜4 times faster i.e. within a window of ˜50 μs after the prompt signal. Thus, a control unit arranged to receive the electrical signal from the photo-detector may by arranged to determine whether an antineutrino has been detected based on the time interval τ and a predetermined threshold. If the two events are separated by more than the predetermined threshold, then the control unit may determine that they do not correspond to antineutrino detection. The detector 500 shown in FIG. 5 allows antineutrino detection when both the prompt event and delayed event occur within the detector. However, it will be appreciated that, depending on the size (particularly the axial cross section dimensions) of the detector 500, the neutron may leave the detector without absorption in the convertor layer 510. Use of a detector assembly as shown in FIG. 7 may improve the neutron detection. The neutron may be detected in another detector from the positron.

A control unit arranged to receive from photo-detectors responsive to signals from a plurality of detectors may correlate the signals from the different detectors to determine the antineutrino detection. In some embodiments of the invention, the control unit may be arranged to determine an initial direction of the antineutrino prior to interaction with the detector assembly based on a vector or distance and direction between detectors outputting the prompt and delayed signals. Whilst the positron from the prompt interaction is weakly isotropic (weakly backward with approximately −3 percent asymmetry), the neutron recoil is directed in a cone with an axis along the initial antineutrino direction. An angle of the cone depends upon the antineutrino energy; it has a maximal value of approximately 55°. The neutron deviates by an average angle of cos θ=2/3 A where A is a mass number of a scattering nucleus. Thus in a proton rich target having a predominant mass number of 1, the direction is preserved. The control unit is therefore able to reconstruct the initial direction of the antineutrino based upon detection positions of the positron and neutron i.e. in which detectors of the detector assembly they are respectively detected.

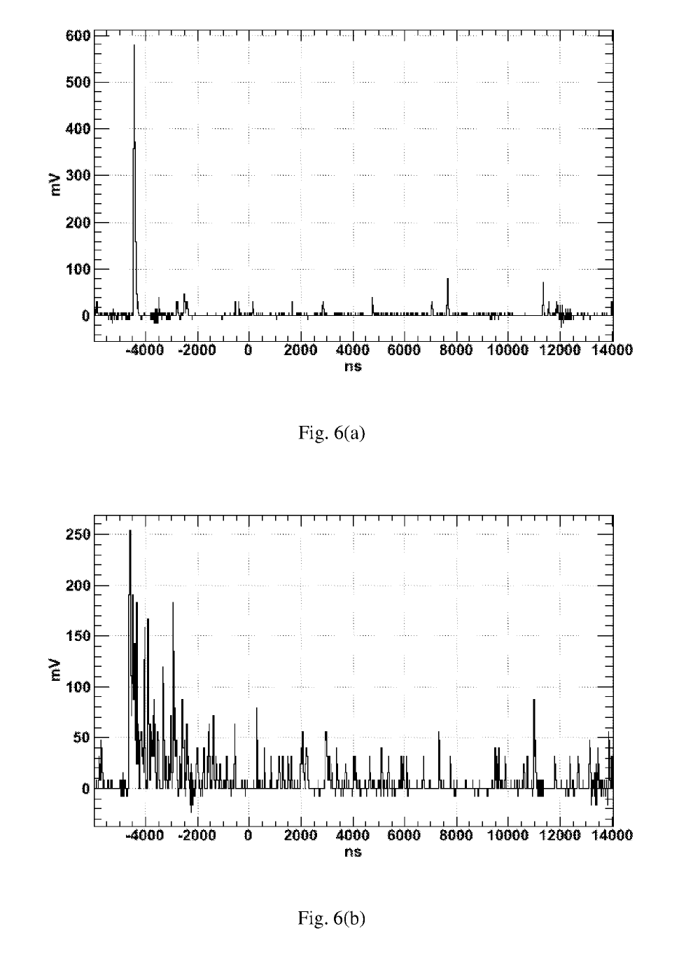

FIG. 6 illustrates an output of a photo-detector used with embodiments of the present invention for different radiation types. FIG. 6(a) illustrates an output due to gamma radiation and FIG. 6(b) illustrates an output due to a neutron interaction. The signal from the AmBe source which corresponds to neutron radiation demonstrates that an output of the photo-detector resulting from neutron detection may be discriminated from other radiation types, such as that shown in FIG. 6(a) due to its longer decay tail due to a larger amount of light collected from neutron absorption in the converter layer 110. The use of the converter layer 110 comprising an inorganic scintillator and a body 120 comprising a plastic scintillator further allows the neutron signal to be discriminated as they have different timing scintillating properties, which allows the separation of the neutron signal from other charged particle signals by pulse shape discrimination (PSD).

In some embodiments the body 520 may be formed by a material which enables discrimination between events resulting from fast neutrons (resulting in proton recoil) and gamma radiation on the basis of PSD. These embodiments enable discrimination between thermal neutrons, fast neutrons and gamma radiation. In these embodiments the body 520 is formed to have a dye concentration, such as PPO, of at least 15% by weight. The dye concentration may be at least 25%, 35% or at least 40% by weight. It has been observed that at sufficiently high levels of dye concentration exhibit high levels of PSD. Further details of the plastic material may be found in “Plastic scintillators with efficient neutron/gamma pulse shape discrimination”, N. Zaitsevaet al, Nuclear Instruments and Methods in Physics Research Section A: Accelerators, Spectrometers, Detectors and Associated Equipment, Volume 668, 11 March 2012, Pages 88-93.

Utilising such a plastic body 520 fast neutrons can be detected in a similar manner to antineutrinos by detecting a prompt event from a proton recoil and delayed event from a neutron. In this way a spectroscopic capability for neutron radiation in the MeV region is provided. Furthermore, directionality detection is possible by examining a location of a prompt event and a delayed event, as will be explained with reference to the system of FIG. 7.

Advantageously this allows the detection of neutrons with a spectroscopic capability to determine a type of radiation source responsible for the radiation. Similarly, the directional capability may reduce background neutron events from the atmosphere. This capability has consequences in dosimetry, security, military applications and enables more sensitive radiation detection.

FIG. 7 illustrates a detector assembly 600 according to an embodiment of the invention. The detector assembly includes a plurality of detectors 500 as shown in FIG. 5, although it will be appreciated that an assembly may be formed in the same way utilising detectors from any previously described embodiment. The assembly 600 may be used for muon tomography, as noted above.

The plurality of detectors are co-located to substantially tessellate by stacking detectors and arranging stacks of detectors side-by-side. Adjoining detectors are generally in contact to form the detector assembly 600. For example, a first (upper) row 601 of detectors includes four individual detectors 601, 602, 603, 604 in side-by-side arrangement. The detector assembly 600 comprises four rows of detectors 601, 611, 621, 631. Not all detectors in FIG. 7 are numbered for clarity. Thus the detector assembly of FIG. 6 comprises sixteen detectors. It will be realised that the cross-sectional shape of the detectors, and thus of the resulting assembly, and the number of detectors may be chosen appropriately.

The detector assembly of FIG. 7 may provide improved detection of the inverse beta decay process described with reference to FIG. 5. An antineutrino may interact with a hydrogen atom of the body of a first detector, such as detector 623. The resultant photons within the body of the first detector 623 caused by the positron of the prompt event are observed by a control unit (not shown) as a first electrical pulse from one or more photo-detectors connected to the fibre of the first detector 623. However, the resultant neutron may be absorbed by the convertor layer of another detector, such as a second detector 612 wherein photons corresponding to scintillation in the convertor layer of the second detector are output as an electrical pulse from one or more photo-detectors connected to the fibre of the second detector 612 to the control unit. The control unit is arranged to compare a timing of the pulses and a distal relationship of the first and second detectors 623, 612 to determine whether antineutrino detection has occurred.

It will be noted that an embodiment may be formed similar to that shown in FIG. 6 but with detectors arranged in two or more orientations. For example, one or more detectors may be arranged in an x-direction whilst one or more detectors may be arranged in a y-direction. This enabled 3D position resolution of interaction with the detector to be determined. The detectors may be arranged in non-parallel orientations which are not limited to being 90° apart.

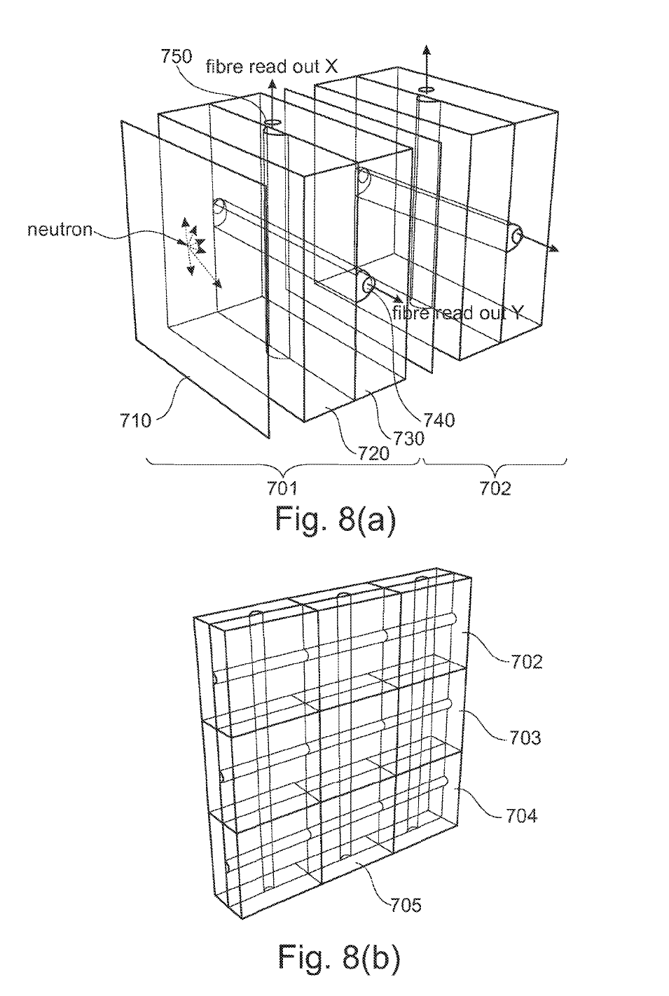

FIG. 8(a) illustrates a cell 700 of a detector assembly 700 according to another embodiment of the invention. The cell 700 is formed by one or more detector layers 701, 702. The cell 700 shown in FIG. 7 comprises two detector layers 701, 702, although it will be appreciated that other numbers of layers may be envisaged. Each of the detector layers 701, 702 comprises a neutron convertor layer 710 (reference numerals are only provided with respect to the first layer 701 for clarity) and a body formed by first and second body layers 720, 730 wherein first and second wavelength shifting fibres are arranged in respective channels formed between the body layers 720, 730. The first and second fibres are arranged in non-parallel directions to provide spatial resolution of detection, as will be explained. In the embodiment shown in FIG. 8, the fibres 740, 750 are in perpendicular arrangement, although other non-parallel arrangements may be envisaged. Furthermore, whilst the detector shown in FIG. 8 is formed by first and second body layers each having a channel in a surface thereof, the detector may be formed from an integral body having holes arranged there-through. A reflective layer, although not shown in FIG. 8, may be applied to outer surfaces of the body which are not covered by the convertor layer 110.

The detector assembly is shown in FIG. 8(b) more completely. The detector assembly shown in FIG. 8(b) comprises one layer of detector cells, unlike the cell shown in FIG. 8(a) which comprises two layers 701, 702. The cells are arranged in side-by-side arrangement to form a layer of substantially continuous cells having a grid of fibres running there-through. That is, each of the fibres runs through a plurality of cells. Determination of which cell a detection event has occurred in is made by a control unit (not shown) based upon photo-detectors simultaneously providing output signals i.e. in both x and y directions. Thus the detector assembly provides 2D of FIG. 8(b) provides 2D resolution of radiation detection. In a detector assembly formed from a plurality of layers of cells, 3D resolution can be achieved. The detector assembly may be formed from detectors as in any previously described embodiment.

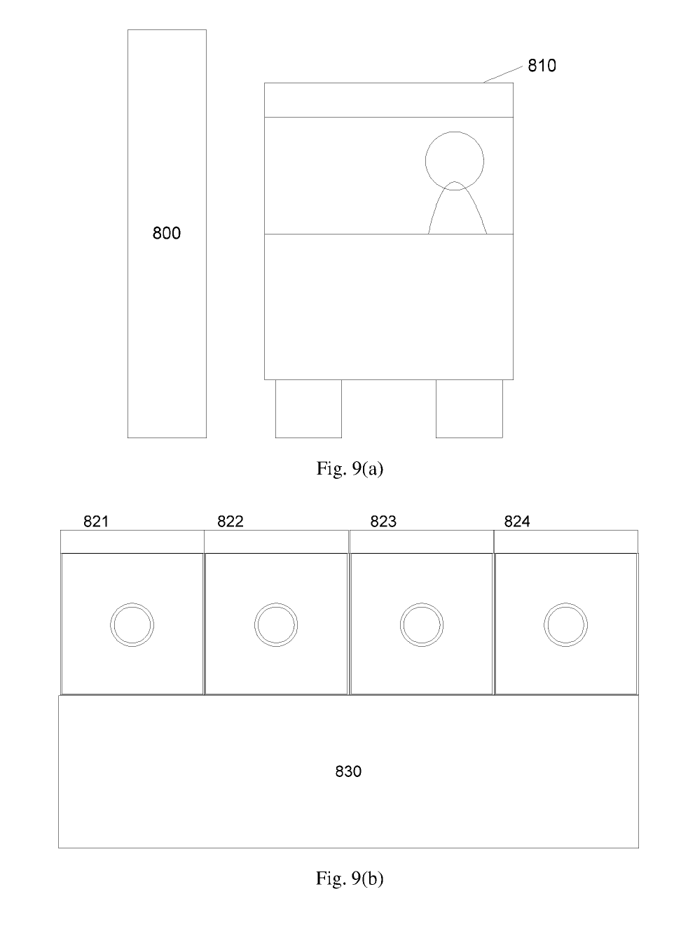

FIG. 9(a) illustrates a detector assembly 800 according to a further embodiment of the invention arranged in use for detecting radiation emitted from a vehicle, such as a wagon or truck 810. The detector 800 is a detector according to an embodiment of the invention arranged in a generally vertical orientation alongside where the vehicle 810 passes, such as a roadway at a customs point. The detector 800 may be useful in detecting cargo including sources of radiation carried by the vehicle. The detector assembly may be particularly useful for detecting neutron radiation emitted from the vehicle, such as the detector assembly 800 may have a length similar to a height of the vehicle e.g. 2-4 m.

FIG. 9(b) shows an axial cross section through an embodiment of the detector 800. The detector 800 comprises a plurality of elongate radiation detectors 821-824 as described with reference to FIGS. 1-3, although it will be realised that detectors such as those shown in FIGS. 4 and 5 may be used, in particular a double-sided detector such as that shown in FIG. 4. Each detector has a square cross-section as shown in FIG. 9(b), although it will be realised that other cross sections may be used. The detectors are arranged side-by-side upon a moderator 830. The moderator is a slab or hydrogen rich material, such as plastic, wax or other material suitable for moderating i.e. reducing an energy of incident neutrons. The moderator 830 is useful to reduce the energy of incident neutrons to increase a likelihood of neutron capture by the convertor layers of the detectors. The detector 800 may comprise a plurality of layers of the detector shown in FIG. 9(b) i.e. a plurality of moderator-detector layers. The detector may be used to replace ³He n-counter detectors currently used in cargo radiation portal monitors.

It will be appreciated that embodiments of the present invention can be realised in the form of hardware or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A radiation detector, comprising:
a convertor comprising an inorganic scintillator for absorbing incident neutrons and outputting photons;
a light collecting body arranged in relation to a wavelength shifting fibre for receiving photons from the convertor and directing the photons to the wavelength shifting fibre; and
one or more photo-detectors arranged to receive photons from the wavelength shifting fibre and output electrical signals in response thereto.

2. The radiation detector of claim 1, comprising a light reflecting layer arranged around the body to inwardly reflect photons toward the wavelength shifting fibre.

3. The radiation detector of claim 1, wherein the wavelength shifting fibre is arranged in a channel through the body.

4. The radiation detector of claim 3, wherein the wavelength shifting fibre is arranged in the channel such that a gap exists between an outer periphery of the fibre and an interior surface of the channel.

5. The radiation detector of claim 1, wherein the inorganic scintillator is zinc sulphide.

6. The radiation detector of claim 1, comprising a first photo-detector arranged at a first end of the fibre and a second photo-detector arranged at a second end of the fibre.

7. The radiation detector of claim 6, comprising a control unit arranged to determine a position of the radiation detection based upon a relative timing of signals from the first and second photo-detectors.

8. The radiation detector of claim 1, wherein the body is arranged in relation to a plurality of wavelength shifting fibres arranged in non-parallel orientations.

9. The radiation detector of claim 1, wherein the body has an axial cross section shape selected from semi-circular, parabolic, triangular or rectangular.

10. The radiation detector of claim 1, wherein the convertor is a layer arranged upon a generally planar surface of the body.

11. The radiation detector of claim 1, comprising a second body arranged in relation to a second wavelength shifting fibre, wherein the bodies are interposed by the convertor layer.

12. The radiation detector of claim 1, wherein the body comprises a an organic scintillator.

13. The radiation detector of claim 12, wherein the plastic scintillator comprises POP and POPOP.

14. The radiation detector of claim 12, wherein the plastic scintillator is arranged for emitting photons in response to charged particles.

15. The radiation detector of claim 12, wherein the charged particles result from an inverse beta decay reaction; optionally the charged particles are positrons.

16. The radiation detector of claim 14, wherein the charged particles are muons.

17. The radiation detector of claim 12, wherein a control unit is arranged to determine radiation detection according to a temporal relationship of a prompt response and a delayed response.

18. The radiation detector of claim 17, wherein the control unit is arranged to determine the radiation detection according to the prompt response, the delayed response and a predetermined time threshold.

19. A detector assembly comprising a plurality of radiation detectors according to claim 1.

20. The detector assembly of claim 19, wherein the plurality of radiation detectors are arranged generally side-by-side.

21. The detector assembly of claim 19, wherein the plurality of radiation detectors are arranged in stacked relation.

22. The detector assembly of claim 19, when dependent upon claim 17, wherein the control unit is arranged to determine the radiation detection, at least in part, upon a distance or/and direction between a detector outputting the prompt response and a detector outputting the delayed response.

23. The detector assembly of claim 22, wherein the control unit is arranged to determine an initial direction of travel of incident radiation based upon a location of detection of the prompt response and the delayed response.

24. The detector assembly of claim 19, when dependent upon claim 8 or any claim dependent thereon, wherein a control unit is arranged to determine a location of radiation detection based upon an output of a plurality of photo-detectors arranged responsive to non-parallel fibres.

25. The detector assembly of claim 19, comprising a moderator for moderating incident neutrons.

26. The detector assembly of claim 25, wherein the detectors are arranged along a major planar surface of the moderator.
